(19) United States
(12) Patent Application Publication
(10) Pub. No.: US 2013/0205129 A1
(43) Pub. Date: Aug. 8, 2013

(54) BASEBOARD MANAGEMENT CONTROLLER SYSTEM

(71) Applicant: HSIU-HUI PENG, Tu-Cheng (TW)

(72) Inventor: HSIU-HUI PENG, Tu-Cheng (TW)

(21) Appl. No.: 13/654,581

(22) Filed: Oct. 18, 2012

(30) Foreign Application Priority Data
Feb. 6, 2012 (TW) 101103721

(51) Int. Cl. G06F 15/177

(52) U.S. Cl. 713/2

(57) ABSTRACT

A baseboard management controller (BMC) system for an electronic device includes a BMC, a multiplex switch, a manual operation element, a main storage, and a backup storage. Manual operations applied to the manual operation element are capable of selecting electrical connection statuses of the multiplex switch. Both the main storage and the backup storage store boot program of the electronic device. The BMC is selectively electrically connected to either the main storage or the backup storage via the multiplex switch and the manual operation element, and selectively calls the boot program stored in either the main storage or the backup storage to actuate the electronic device.

### BACKGROUND

1. Technical Field

The present disclosure relates to baseboard management controller (BMC) systems, and particularly to a BMC system that enables manual data recovery.

2. Description of Related Art

An electronic device, such as a personal computer (PC), may include a main storage and a backup storage. Each of the main storage and the backup storage stores a boot program. A baseboard management controller (BMC) of the electronic device can be simultaneously electrically connected to the main storage and the backup storage via a multiplex switch. In use, prior to the electronic device being actuated, the BMC calls the boot program stored in the main storage. If the main storage malfunctions, or if the boot program stored in the main storage is lost or damaged, the BMC calls the boot program stored in the backup storage to actuate the electronic device, and recovers the boot program in the main storage.

However, in the above-described system, the malfunction of the main storage may cause abnormal conditions in the multiplex switch. Thus, the electric connection between the BMC and the backup storage may fail, and the BMC may be unable to call the boot program stored in the backup storage. Furthermore, when the BMC is recovering the boot program in the main storage, the recovering process may be interrupted by external interference, such as sudden loss of electrical power supply or operation errors of the electronic device.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the various figures.

FIG. 1 is a block diagram of a baseboard management controller (BMC) system, according to an exemplary embodiment.

FIG. 2 shows a part of the block diagram of FIG. 1 relating to calling a boot program stored in a main storage of the BMC system.

FIG. 3 shows a part of the block diagram of FIG. 1 relating to automatically calling a boot program stored in a backup storage of the BMC system.

FIG. 4 shows a part of the block diagram of FIG. 1 relating to automatically recovering the boot program in the main storage of the BMC system.

FIG. 5 shows a part of the block diagram of FIG. 1 relating to manually calling the boot program stored in the backup storage of the BMC system.

FIG. 6 shows a part of the block diagram of FIG. 1 relating to manually recovering the boot program in the main storage of the BMC system.

### DETAILED DESCRIPTION

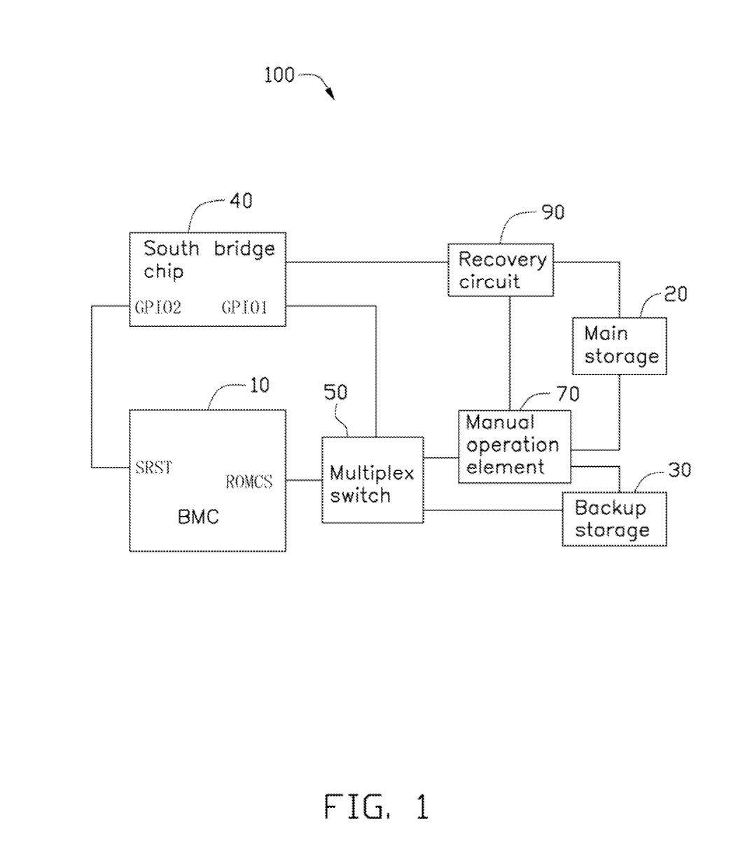

FIG. 1 is a block diagram of a baseboard management controller (BMC) system 100, according to an exemplary embodiment. The BMC system 100 is used in an electronic device, such as a personal computer (PC).

The BMC system 100 includes a BMC 10, a main storage 20, a backup storage 30, a south bridge chip 40, a multiplex switch 50, a manual operation element 70, and a recovery circuit 90. The multiplex switch 50 and the manual operation element 70 are electrically connected in series between the BMC 10 and the main storage 20, and the backup storage 30 is electrically connected to both the multiplex switch 50 and the manual operation element 70. The south bridge chip 40 is electrically connected to the BMC 10 and the multiplex switch 50. The recovery circuit 90 is electrically connected to the south bridge chip 40, the manual operation element 70, and the main storage 20. The manual operation element 70 can be a mechanical switch element. Manual operations applied to the manual operation element 70 can select electrical connection statuses of the multiplex switch 50.

In this embodiment, a type of the BMC 10 is AST2150. The BMC 10 includes a reset pin SRST and a selection pin ROMCS. The reset pin SRST is electrically connected to the south bridge chip 40. Upon receiving an electronic signal with a predetermined voltage (e.g., a logic “1” signal) from the reset pin SRST, the BMC 10 actuates or resets the electronic device. The selection pin ROMCS is electrically connected to the multiplex switch 50.

In this embodiment, each of the main storage 20 and the backup storage 30 is a Flash memory having a serial peripheral interface (SPI), and stores the boot program of the electronic device. When the electronic device is actuated or reset, the BMC 10 needs to call the boot program stored in the main storage 20 or the backup storage 30.

The south bridge chip 40 can be an I/O controller hub (ICH) or a platform controller hub (PCH), and includes a first general purpose input output (GPIO) pin GPIO1 and a second GPIO pin GPIO2. The first GPIO pin GPIO1 is electrically connected to the multiplex switch 50. The south bridge chip 40 can control the multiplex switch 50 to selectively connect either the main storage 20 (i.e., via the manual operation element 70) or the backup storage 30 to the BMC 10 via the first GPIO pin GPIO1. The second GPIO pin GPIO2 is electrically connected to the reset pin SRST of the BMC 10, so that the south bridge chip 40 can control the BMC 10 to actuate the electronic device via the second GPIO pin GPIO2.

The recovery circuit 90 can be a write circuit configured for writing the boot program into the main storage 20. Upon receiving a control instruction from the south bridge chip 40 or the manual operation element 70, the recovery circuit 90 writes the boot program into the main storage 20, thereby recovering the boot program in the main storage 20. The boot program written into the main storage 20 by the recovery circuit 90 can be the boot program stored in the backup storage 30 (i.e., sent to the recovery circuit 90 via the manual operation element 70 or other common electrical connections in the electronic device), and can also be stored in other common storage elements of the electronic device.

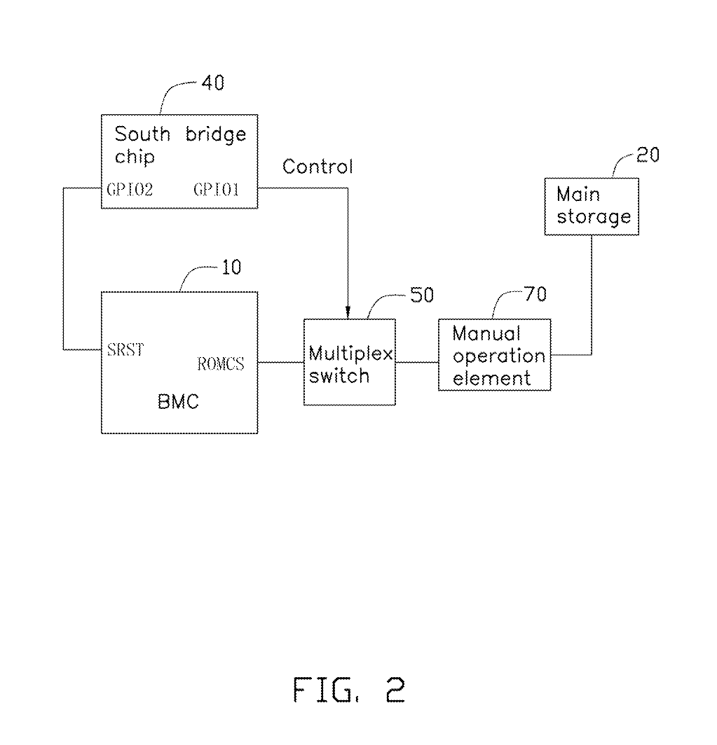

Referring to FIG. 2, in use, prior to the electronic device being actuated, the BMC 10 calls the boot program stored in the main storage 20. Therefore, in a default situation of the BMC system 100, the south bridge chip 40 controls the multiplex switch 50 to electrically connect the manual operation element 70 to the selection pin ROMCS of the BMC 10, and the manual operation element 70 is set to electrically connect the main storage 20 to the multiplex switch 50. Thus, the main storage 20 is electrically connected to the selection pin ROMCS of the BMC 10, and the BMC 10 calls the boot program stored in the main storage 20, upon the control of the south bridge chip 40 via the second GPIO pin GPIO2.

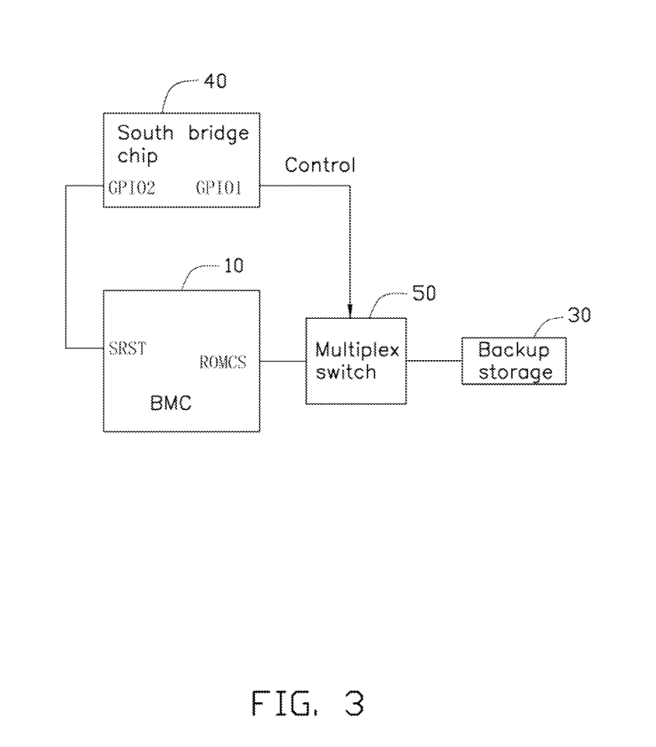

Referring to FIG. 3, if the main storage 20 malfunctions, or the boot program stored in the main storage 20 is lost or damaged, the BMC 10 calls the boot program stored in the backup storage 30 to actuate the electronic device. In this situation, if the multiplex switch 50 is capable of automatically connecting the backup storage 30 to the BMC 10, the south bridge chip 40 controls the multiplex switch 50 to electrically connect the backup storage 30 to the selection pin ROMCS of the BMC 10. Thus, the BMC 10 calls the boot program stored in the backup storage 30, upon the control of the south bridge chip 40 via the second GPIO pin GPIO2.

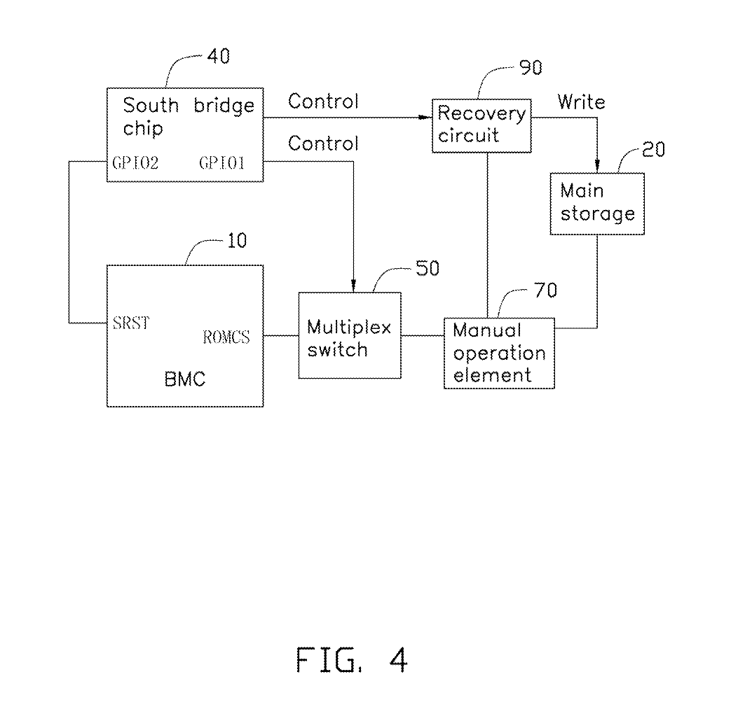

If the electronic device has been actuated according to the situation shown in FIG. 3, the BMC system 100 can automatically recover the boot program in the main storage 20. Referring to FIG. 4, upon determining that the BMC 10 has actuated the electronic device, the south bridge chip 40 controls the recovery circuit 90 to write the boot program into the main storage 20, thereby recovering the boot program in the main storage 20. Furthermore, the south bridge chip 40 controls the multiplex switch 50 to electrically connect the manual operation element 70 to the selection pin ROMCS of the BMC 10 again. Thus, when the electronic device is used the next time, the BMC 10 can actuate the electronic device according to the situation shown in FIG. 1.

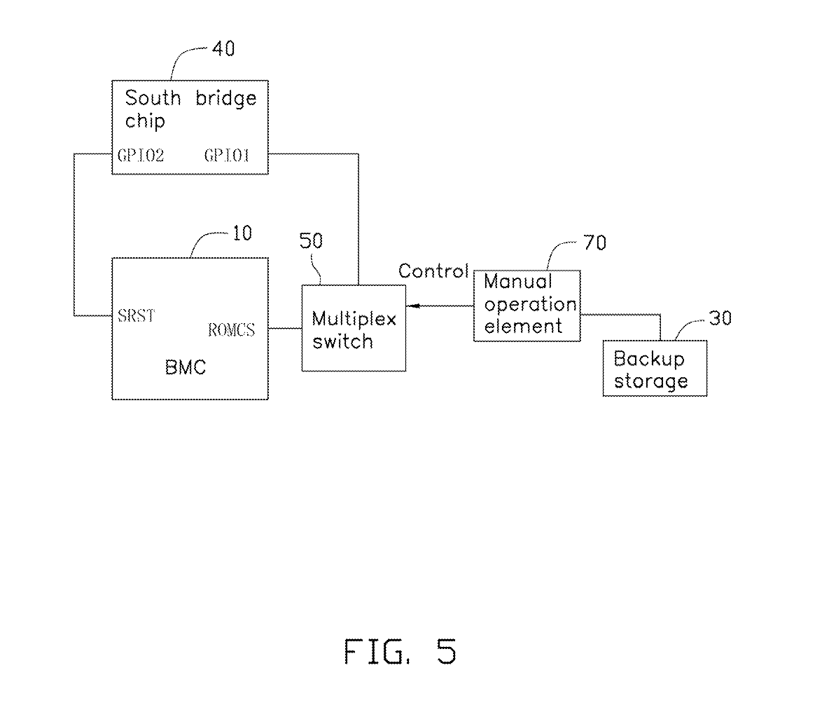

Referring to FIG. 5, if the main storage 20 malfunctions or the boot program stored in the main storage 20 is lost or damaged, and the multiplex switch 50 is incapable of automatically connecting the backup storage 30 to the BMC 10 (e.g., the multiplex switch 50 is interfered with by the malfunction of the main storage 20), the boot program stored in the backup storage 30 needs to be manually called to actuate the electronic device. In this situation, the manual operation element 70 is manually operated to control the electrical connection status of the multiplex switch 50, so that the multiplex switch 50 is controlled to electrically connect the backup storage 30 to the selection pin ROMCS of the BMC 10. Thus, the BMC 10 calls the boot program stored in the backup storage 30, upon the control of the south bridge chip 40 via the second GPIO pin GPIO2.

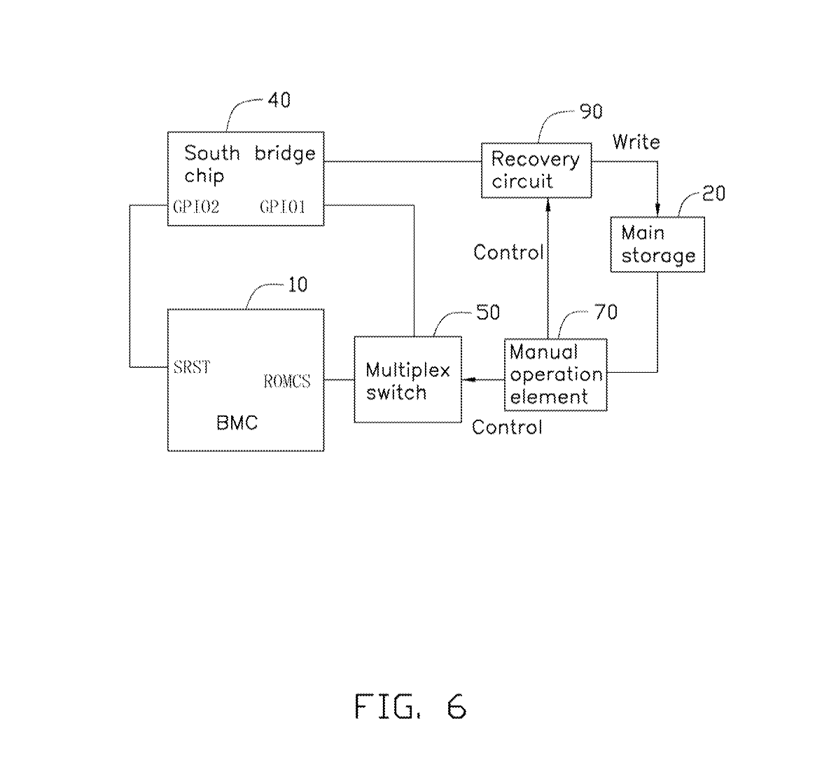

When the electronic device has been actuated according to the situation shown in FIG. 5, the boot program needs to be manually recovered in the main storage 20. Referring to FIG. 6, after the electronic device is actuated, the manual operation element 70 is manually operated to send an instruction to the recovery circuit 90. The instruction controls the recovery circuit 90 to write the boot program into the main storage 20, thereby recovering the boot program in the main storage 20. Furthermore, by manually operating the manual operation element 70, the multiplex switch 50 is controlled to electrically connect the manual operation element 70 to the selection pin ROMCS of the BMC 10 again. Thus, when the electronic device is used the next time, the BMC 10 can actuate the electronic device according to the situation shown in FIG. 1.

In the present disclosure, the BMC system 100 is capable of either automatically or manually actuating the electronic device and recovering the boot program stored in the main storage 20, according to prevailing circumstances. If the main storage 20 malfunctions or the boot program stored in the main storage 20 is lost or damaged, and regardless of whether or not the multiplex switch 50 is interfered with by malfunction of the main storage 20, the electronic device is capable of being normally actuated and reset, and the boot program stored in the main storage 20 can be easily recovered.

It is to be further understood that even though numerous characteristics and advantages of the present embodiments have been set forth in the foregoing description, together with details of structures and functions of various embodiments, the disclosure is illustrative only, and changes may be made in detail, especially in matters of arrangement of parts within the principles of the present invention to the full extent indicated by the broad general meaning of the terms in which the appended claims are expressed.

What is claimed is:

1. A baseboard management controller (BMC) system for an electronic device, comprising:
a BMC;
a multiplex switch electrically connected to the BMC;
a manual operation element electrically connected to the multiplex switch, manual operations applied to the manual operation element being capable of selecting electrical connection statuses of the multiplex switch;
a main storage storing a boot program of the electronic device, and electrically connected to the manual operation element; and
a backup storage also storing the boot program of the electronic device, and electrically connected to both the multiplex switch and the manual operation element;
wherein the BMC is capable of being electrically connected to the main storage via the multiplex switch and the manual operation element and of calling the boot program stored in the main storage to actuate the electronic device, and capable of being electrically connected to the backup storage via the multiplex switch and of calling the boot program stored in the backup storage to actuate the electronic device; and
wherein the manual operations applied to the manual operation element enable the BMC to be manually electrically connected to the backup storage and to call the boot program stored in the backup storage to actuate the electronic device.

2. The BMC system of claim 1, wherein in a default status of the BMC system, the BMC is electrically connected to the main storage via the multiplex switch and the manual operation element and calls the boot program stored in the main storage to actuate the electronic device.

3. The BMC system of claim 2, wherein when the main storage malfunctions or the boot program stored in the main storage is lost or damaged, the BMC is electrically connected to the backup storage via the multiplex switch and calls the boot program stored in the backup storage to actuate the electronic device.

4. The BMC system of claim 3, wherein when the main storage malfunctions or the boot program stored in the main storage is lost or damaged, and the multiplex switch is incapable of automatically connecting the backup storage to the BMC, the manual operation element is manually operable to electrically connect the BMC to the backup storage via the multiplex switch and the manual operation element, and further manually operable whereby the BMC calls the boot program stored in the backup storage to actuate the electronic device.

5. The BMC system of claim 4, further comprising a south bridge chip electrically connected to the BMC and the multiplex switch.

6. The BMC system of claim 5, wherein the BMC actuates the electronic device upon control of the south bridge chip.

7. The BMC system of claim 5, wherein the multiplex switch electrically connects either the manual operation element or the backup storage to the BMC upon control of the south bridge chip.

8. The BMC system of claim 5, further comprising a recovery circuit electrically connected to the main storage; wherein when the boot program stored in the main storage is lost or damaged and the BMC has called the boot program stored in the backup storage to actuate the electronic device, the recovery circuit recovers the boot program in the main storage.

9. The BMC system of claim 8, wherein the recovery circuit is electrically connected to the south bridge chip, and recovers the boot program in the main storage upon control of the south bridge chip.

10. The BMC system of claim 8, wherein the recovery circuit is electrically connected to the manual operation element, and recovers the boot program in the main storage upon control of an instruction sent from the manual operation element.

11. The BMC system of claim 10, wherein the boot program stored in the backup storage is sent to the recovery circuit, and the recovery circuit writes the boot program into the main storage to recover the boot program in the main storage.

12. A baseboard management controller (BMC) system for an electronic device, comprising:
a BMC;
a multiplex switch electrically connected to the BMC;
a manual operation element electrically connected to the multiplex switch, manual operations applied to the manual operation element being capable of selecting electrical connection statuses of the multiplex switch;
a main storage storing a boot program of the electronic device, and electrically connected to the manual operation element;
a backup storage also storing the boot program of the electronic device, and electrically connected to both the multiplex switch and the manual operation element; and
a south bridge chip electrically connected to the BMC and the multiplex switch;
wherein the multiplex switch electrically connects either the manual operation element or the backup storage to the BMC upon control of the south bridge chip, and the BMC is thereby electrically connected to the main storage via the multiplex switch and the manual operation element and calls the boot program stored in the main storage to actuate the electronic device, or is electrically connected to the backup storage via the multiplex switch and calls the boot program stored in the backup storage to actuate the electronic device; and
wherein the manual operations applied to the manual operation element enables the BMC to be manually electrically connected to the backup storage and call the boot program stored in the backup storage to actuate the electronic device.

13. The BMC system of claim 12, wherein in a default status of the BMC system, the BMC is electrically connected to the main storage via the multiplex switch and the manual operation element and calls the boot program stored in the main storage to actuate the electronic device.

14. The BMC system of claim 13, wherein when the main storage malfunctions or the boot program stored in the main storage is lost or damaged, the BMC is electrically connected to the backup storage via the multiplex switch and calls the boot program stored in the backup storage to actuate the electronic device.

15. The BMC system of claim 14, wherein when the main storage malfunctions or the boot program stored in the main storage is lost or damaged, and the multiplex switch is incapable of automatically connecting the backup storage to the BMC, the manual operation element is manually operated to electrically connect the BMC to the backup storage via the multiplex switch and the manual operation element, and the BMC calls the boot program stored in the backup storage to actuate the electronic device.

16. The BMC system of claim 15, further comprising a recovery circuit electrically connected to the main storage; wherein when the boot program stored in the main storage is lost or damaged and the BMC has called the boot program stored in the backup storage to actuate the electronic device, the recovery circuit recovers the boot program in the main storage.

17. The BMC system of claim 16, wherein the recovery circuit is electrically connected to the south bridge chip, and recovers the boot program in the main storage upon control of the south bridge chip.

18. The BMC system of claim 16, wherein the recovery circuit is electrically connected to the manual operation element, and recovers the boot program in the main storage upon control of an instruction sent from the manual operation element.

19. The BMC system of claim 18, wherein the boot program stored in the backup storage is sent to the recovery circuit, and the recovery circuit writes the boot program into the main storage to recover the boot program in the main storage.
